(19) United States
(12) Patent Application Publication
(10) Pub. No.: US 2010/0283274 A1
(43) Pub. Date: Nov. 11, 2010

(54) CLAMPING CELL WITH FORCED OPEN FUNCTION

(75) Inventor: Marcel Antonius Maria Swinkels, Asten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,588

(22) PCT Filed: Nov. 6, 2007
(86) PCT No.: PCT/IB2007/054506

§ 371 Date: Apr. 7, 2009

Related U.S. Application Data
(60) Provisional application No. 60/866,861, filed on Nov. 22, 2006.

(51) Int. Cl. B25J 15/00

(52) U.S. Cl. 294/106

(57) ABSTRACT

A clamping apparatus is provided employing a forced open function to achieve accurate frictionless adjustment. In an embodiment, a shaft (60) is held by the inventive clamping cell (40) which comprises a clamping block (302) and a screw (304) with two different thread sizes. Nuts (306, 308) with different threads are respectively backed in and out as the screw (304) is turned. The shaft position is thus adjusted to within a required tolerance without causing any friction forces on the shaft (60).

This invention relates to an apparatus and method for achieving accurate frictionless adjustment.

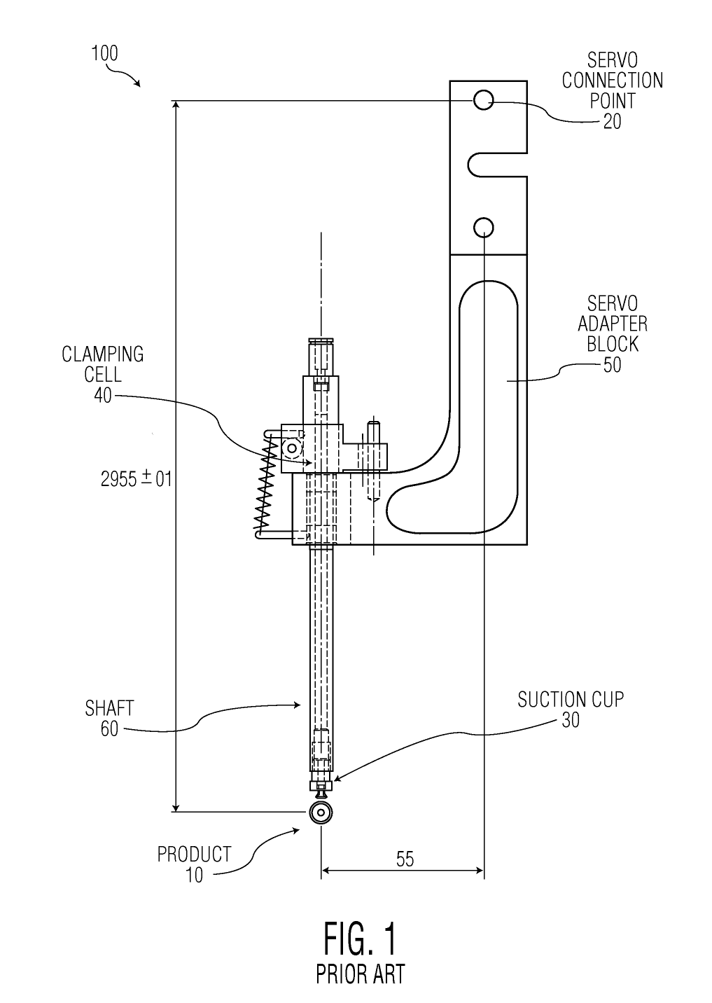

In many prior art devices, such as a leak detection and inspection machines for checking products (in this case, ceramic gas discharge metal halide (“CDM”) lamps), for geometrical failures and leakages, there is a structure, referred to as a gripper unit 100, as shown in FIG. 1. The gripper unit 100 is configured to handle the CDM lamps 10, otherwise referred to as product, by lifting the CDM lamps 10 from a V-block assembly (not shown) and inserting the CDM lamps 10 into a testing unit (not shown) of the detection and inspection machine. The gripper unit 100, as shown in FIG. 1, is generally comprised of a servo adapter block 50 for connection to a servo (not shown), for driving the gripper unit, by means of reference pins 20 (i.e., servo connection point). The gripper unit 100 further comprises a clamping cell 40 coupled by a servo adapter block 50 to the servo. The clamping cell 40 clamps an adjusting shaft 60 which includes a vacuum suction cup 30 attached on a distal end for handling the CDM lamps 10.

It is required that the distance between reference pins 20 on the servo adapter block 50 of the gripper unit 100 and the suction cup 30, attached to the adjusting shaft 60, is 295.5 mm within a tolerance of ±0.1 mm. This adjustment is made on an adjustment jig by removing the gripper unit 100 from the leak detection and inspection machine. The adjustment procedure for achieving such a tolerance involves (a) loosening the clamping cell 40 on the adjustment jig to allow the adjusting shaft 60 to move easily in the guiding bushes 35, (b) allowing the adjusting shaft 60/vacuum suction cup 30 assembly to suck itself to the shaft of the adjustment jig to achieve a dimension of 295.5 mm±0.1 mm between the reference pins 20 on the servo slide 70 and the vacuum suction cup 30, (c) re-tightening the clamping cell to complete the procedure.

FIG. 2 is a top view of the conventional clamping cell 40 of FIG. 1 which further illustrates this undesirable friction force (stick slip). In the top view shown in FIG. 2, the clamping cell 40 is shown to be constructed as having a central hole 22 with substantially the same diameter as the adjusting shaft 60, shown in FIG. 1, for mounting in the central hole 22. A cut 24 is made in the central hole. When the adjusting shaft 60 (see FIG. 1) is mounted in the central hole 22, a screw 26 is rotated to clamp the adjusting shaft 60. When the screw 26 is loosened, to perform the adjustment procedure described above, the clamping cell 40 opens to substantially the same diameter as the adjusting shaft 60 with no positive tolerance. This disadvantageously causes a friction force (stick slip) on the adjusting shaft 60 in the open situation.

A further drawback of the afore-mentioned adjustment procedure occurs at the last step (c). Specifically, due to the handling of the clamping cell 40 when re-tightening, a friction force (stick slip) occurs on the adjusting shaft 60 and the adjustment is lost.

To address these and other problems in the prior art, the present invention is a clamping apparatus employing a forced open function to achieve accurate frictionless adjustment. In an embodiment, a shaft is held by the inventive clamping cell which comprises a clamping block and a screw with two different thread sizes. Nuts with different threads are respectively backed in and out as the screw is turned. The shaft position is thus adjusted to within a required tolerance without causing any friction forces on the shaft.

According to one aspect of the invention, the inventive clamping apparatus allows any size shaft to be easily and accurately positioned with respect to, for example, a servo, cylinder, cam or spring.

In accordance with one embodiment of the present invention, there are provided methods and systems for achieving accurate frictionless adjustment, a method comprising: (a) loosening the clamping cell by rotating a screw mechanism of the clamping cell to cause the clamping cell to be forced open thereby allowing an adjusting shaft assembly to move easily within one or more guiding bushes; (b) allowing the adjusting shaft assembly, attached thereto, to draw itself to a shaft of an adjustment jig to achieve a prescribed dimension and tolerance between a servo connection point and the vacuum suction cup; and (c) manually re-tightening the clamping cell via the screw mechanism on the clamping cell. In accordance with the procedure, a prescribed dimension and tolerance between a servo connection point and the vacuum suction cup is preserved.

These and other objects, features and advantages of the present invention will become apparent through consideration of the Detailed Description of the Invention, when considered in conjunction with the drawing Figures, in which:

FIG. 1 illustrates a gripper unit in the leak detection and inspection machine for checking CDM lamps for geometrical failures and leakages, according to the prior art;

FIG. 2 is a top view of a clamping cell which is an element of the gripper unit of the leak detection and inspection machine of FIG. 1, according to the prior art;

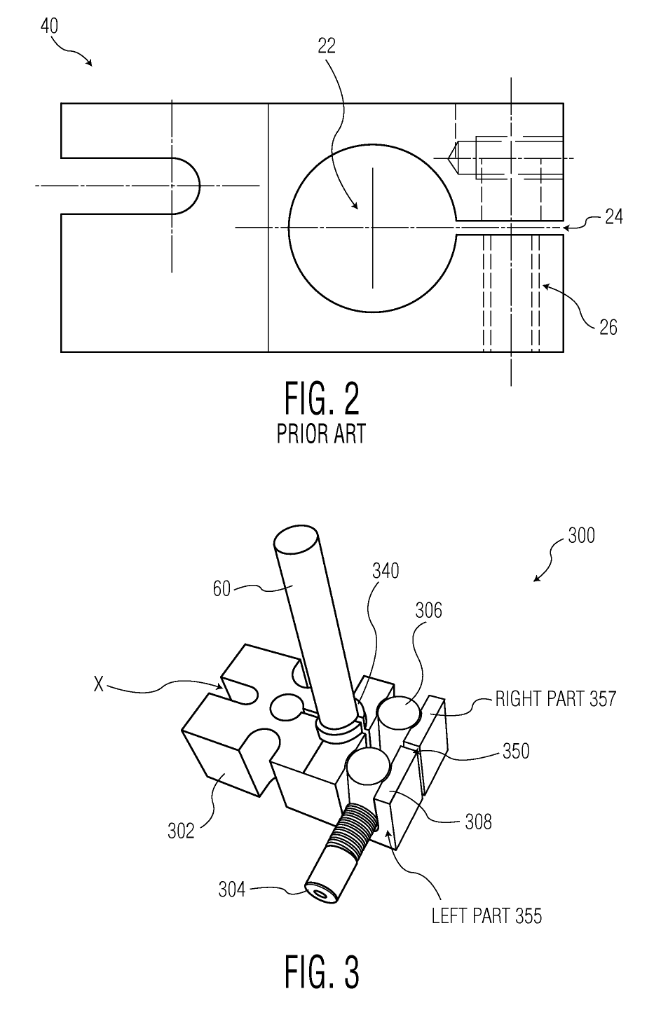

FIG. 3 is a perspective view of a clamping cell, according to one embodiment of the present invention;

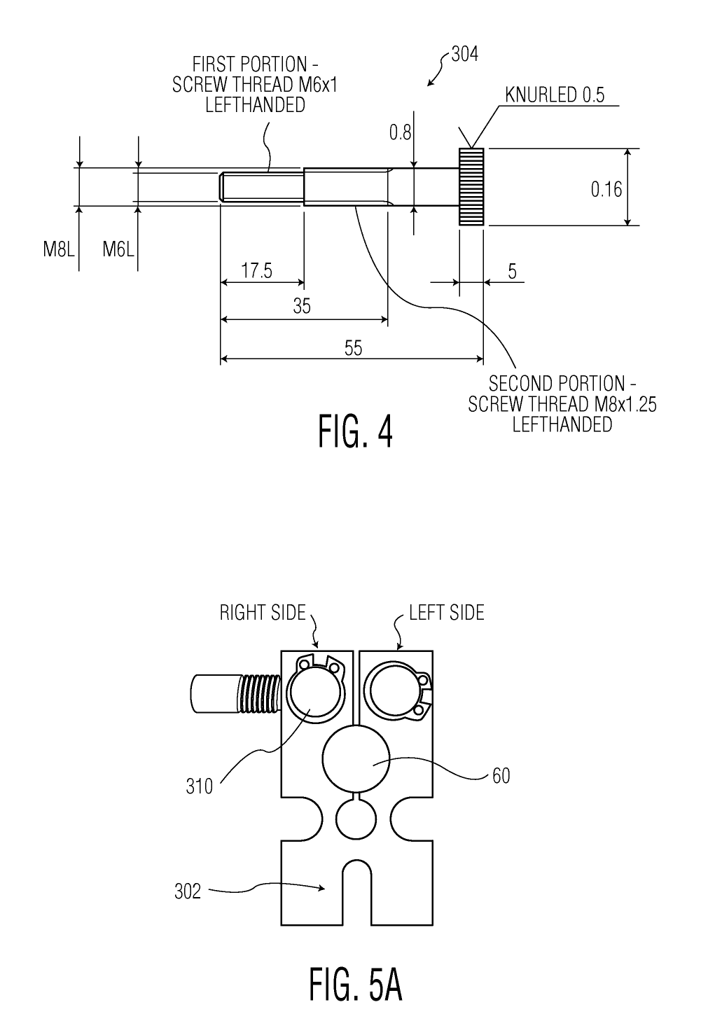

FIG. 4 is a detailed view of the screw 304 having two (2) different thread sizes.

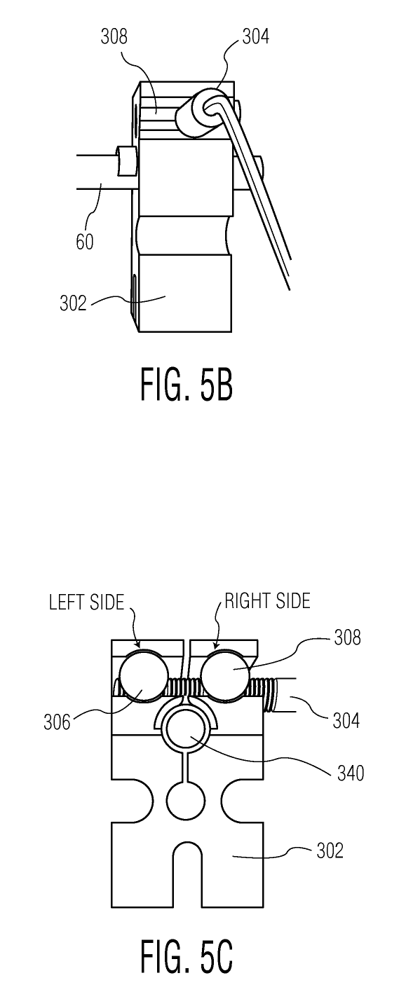

FIG. 5a-c illustrates respective top, bottom and side views of the inventive clamping cell 300, according to one embodiment of the present invention;

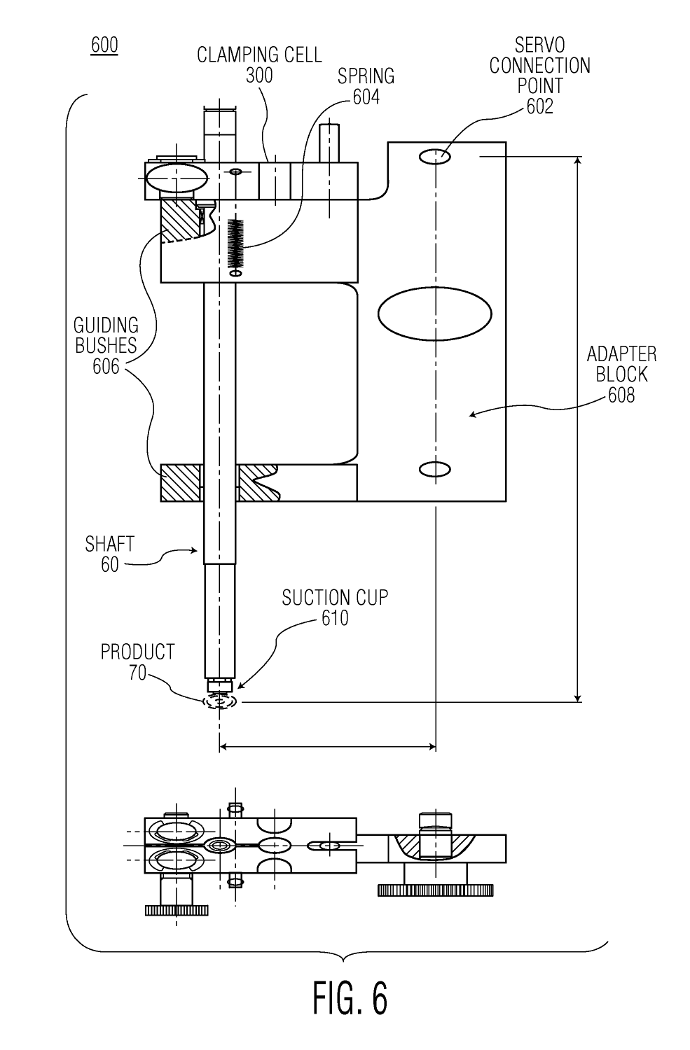

FIG. 6 illustrates a gripper mechanism including the inventive clamping cell, according to one embodiment of the invention; and

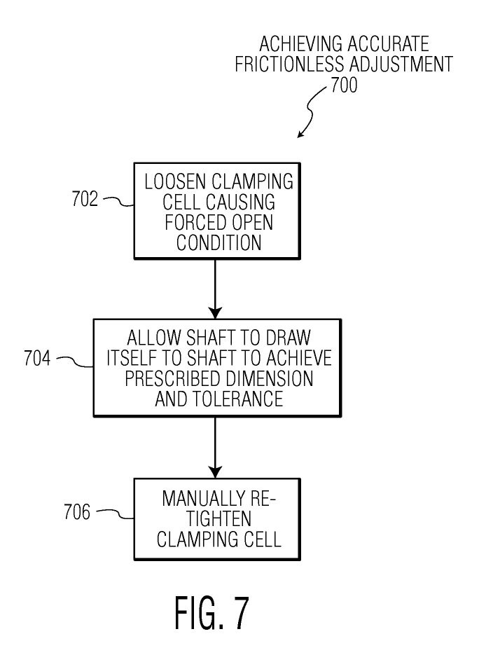

FIG. 7 illustrates a method for illustrates a method for achieving accurate frictionless adjustment, according to one embodiment.

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Referring now to the drawings, and in particular to FIGS. 3-6, a clamping assembly of the present invention, generally indicated at 300, is shown.

FIG. 3 is a perspective view of the clamping cell 300 of the invention. The inventive clamping cell 300 is comprised of a solid clamping block 302 with an accurate fit hole 340 to accommodate an adjusting shaft 60. The clamping cell 300 includes a partial cut 350 in the solid clamping block 302 along a longitudinal axis X, which partially bifurcates the clamping cell 300 in respective left 355 and right 357 parts. The clamping cell 300 further includes a screw 304 having two (2) different thread sizes.

FIG. 4 is a detailed view of the screw 304 having two (2) different thread sizes. In the exemplary embodiment, the screw 304 has a first thread size of M6x1 (LH) and a second thread size of M8×1.25 (LH). A first nut 306 (see FIG. 3) mates with the thread portion of the screw 304 having the first thread size of M6x1 (LH) and a second nut 308 (See FIG. 3) mates with the thread portion of the screw 304 having the second thread size of M8×1.25 (LH). During construction of the clamping cell 300, the screw 304 and nuts 306, 308 are first mounted and then inserted into the clamping block 302. A retaining ring is then used to prevent the respective nuts 304, 306 from loosening.

The inventive clamping cell 300 may be constructed from a wide variety of materials, including, without limitation, steel, aluminum and plastic.

As described above, during a prior art adjustment process, an operator attempts to adjust the shaft 60 of a conventional gripper unit 100 to ensure that the distance between the reference pins 20 on the servo slide 70 of the gripper unit 100 and a suction cup 30, attached to the shaft 60, is adjusted to be, for example, 295.5 mm within a tolerance of ±0.1 mm. However, undesirable friction forces (i.e., stick slip) prevent this adjustment from being maintained due to a manual handling of the clamping cell 300, during a re-tightening phase, thus causing the adjustment to be lost. These undesirable friction forces, otherwise referred to herein as stick slip, are virtually eliminated with the inventive clamping cell 300. The shaft 60 may be held in place by the inventive clamping cell 300 in a manner that allows the shaft position to be adjusted and maintained to within prescribed tolerances by eliminating the aforementioned undesirable friction forces on the shaft, as will be described as follows.

While the present invention is described herein in the context of a testing apparatus, it is understood that the present context is used by way of example and not limitation. That is, the inventive clamping cell is applicable to any application in which it is desired to achieve a frictionless adjustment.

With reference now to FIG. 5a-c, which illustrates top, bottom and side views, respectively, of the inventive clamping cell 300.

Referring first to FIG. 5c, a bottom view of the inventive clamping cell 300 is shown. The primary purpose of the clamping cell is to hold the shaft 60 (shown in FIG. 5a) in position when the gripper unit is in operation. To hold the shaft 60 in position, the inventive clamping cell 300 may be closed (tightened) by an operator by rotating the screw 304 clockwise. Each revolution of the screw 304 causes the right part 357 of the clamping block to move a certain distance (e.g., 1.25 mm) to the left and the left part 355 of the clamping block to move a slightly smaller distance (e.g, 1 mm) to the left. As a result, the distance between the right and left sides of the clamping block becomes shorter by an amount Δx (e.g., 0.25 mm), causing the clamping cell 300 to close.

Continuing with FIG. 5c, the inventive clamping cell 300 may be opened to release the adjusting shaft 60 by rotating the screw 304 counter clockwise. Each revolution of the screw 304 causes the right part 357 of the clamping block 302 to move 1.25 mm to the right and the left part 355 of the clamping block to move 1 mm to the right. As a result, the distance between the right and left sides of the clamping block becomes 0.25 mm larger, thus causing the clamping cell 300 to be effectively opened beyond its natural range, referred to herein as a forced open state. The forced open state refers to a process of opening the clamping cell beyond what would occur naturally by simply loosening the clamping cell in a conventional manner. This forced open state advantageously reduces or otherwise eliminates the undesirable friction forces of the prior art, as described above.

The astute reader will recognize that the forced open state is a result of the differential movement between the right and left sides of the clamping block caused by a difference in the feed of thread. In the presently described embodiment, by way of example only, the thread portion on the right hand side of the screw 304 and corresponding nut 308 have a thread size of M8×1.25 (LH). While, the thread portion on the left hand side of the screw 304 and nut 306 have a corresponding thread size of M6x1 (LH), which results in a forced opening on the order of 0.25 mm. In other embodiments, this differential may be different depending upon the application.

In the presently described embodiment, a left handed thread is described such that the closing and opening operations are the same as a conventional clamping cell 300. One skilled in the art will understand that a right handed thread may be used in other embodiments with the understanding that clockwise rotation is synonymous with opening the clamping cell 300 and counter clockwise rotation is synonymous with closing the clamping cell 300.

The inventive clamping cell 300 may be used for clamping shafts of any diameter to facilitate easy and accurate positioning of the shaft with respect to, for example, a servo, cylinder, cam, spring or the like. Further, there is no restriction on the size and type of threads chosen for the screw 340 portion, with the single exception of conical threads. It is only required is that the thread feeds on the left hand and right hand sides of the screw 304 are different.

FIG. 6 is an illustration of a gripper unit 600, including the inventive clamping cell 300. In normal operation, the gripper unit 600 moves up and down, driven by a servo (not shown) connected to a connection point 602. The shaft 60 is rigidly fixed with respect to the adapter block 608. The inventive clamping cell 300 is shown mounted in the upper left portion of the gripper unit 600, shown clamped to the shaft 60. A spring mechanism 604 is shown attached to the clamping cell 300 on one side and to the adapter block 608 on the other side. The spring mechanism 604 is pre-tensioned to pull the clamping cell 300 towards the adapter block 608. In the case where the shaft 60 and clamping cell 300 are forced vertically upward when attempting to pick up two products 70, simultaneously, the spring mechanism 604 counteracts this upward force.

With continued reference to FIGS. 3-6, it is shown that the clamping cell 300 of the invention may be employed as part of a gripper unit 600 which is a component of a packaging and inspection machine for checking product, such as CDM lamps for geometrical failures and leakages. The gripper unit 600 is driven by a servo (not shown) which drives the gripper unit 600 up and down in a vertical direction to releasably engage and grip the product. The gripping unit 600 includes the inventive clamping cell 300 for clamping an adjusting shaft 60.

It is required that the distance between the servo connection point 602 of the gripper unit 600 and the suction cup 610, attached to the adjusting shaft 60, is, for example, 295.5 mm within a tolerance of ±0.1 mm (See FIG. 6). This adjustment is made on an adjustment jig by removing the gripper unit 600 from the leak detection and inspection machine, as will be described in greater detail with regard to FIG. 7.

With reference now to FIG. 7, a process for achieving accurate frictionless adjustment is comprised of the following steps, according to one embodiment. The process is preferably implemented by disassembling the gripper unit 600 of FIG. 6 from the testing apparatus and connecting it to an adjustment apparatus or jig.

As shown in FIG. 7, the clamping cell 300 is loosened while placed on the adjustment jig by rotating a screw 304 of the clamping cell 300 to cause the clamping cell 300 to be forced open beyond its natural range to allow the adjusting shaft 60 to move easily in the guiding bushes 606 (step 702). The adjusting shaft assembly (i.e., shaft and vacuum suction cup) is allowed to draw itself to the shaft of the adjustment jig, via vacuum means, to achieve a prescribed dimension and tolerance (e.g., 295.5 mm±0.1 mm) between the servo connection point 602 and the vacuum suction cup 30 (step 704). The clamping cell 300 is then manually re-tightened via screw 304 to complete the procedure (step 706).

There have thus been provided new and improved methods and systems for adjusting he distance between the servo connection point and the suction cup attached to the adjusting shaft to within a prescribed tolerance

Although this invention has been described with reference to particular embodiments, it will be appreciated that many variations will be resorted to without departing from the spirit and scope of this invention as set forth in the appended claims. The scope of the invention is indicated in the appended claims, and all changes that come within the meaning and range of equivalents are intended to be embraced therein. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A gripping device for releasably engaging and gripping products for placement at a desired location in a system, said gripping device for releasably engaging and gripping products, for insertion into the system, said gripping device comprising:
an adapter bock;
a spring mechanism;
a clamping cell, comprising:
a clamping block being partially bifurcated into respective left and right portions along a longitudional axis and including an accommodating hole centered along said longitudional axis;
a screw extending in a direction perpendicular to said longitudional axis having two thread sizes, a first thread size for conjoint rotation with a first nut positioned on said left portion of said partially bifurcated clamping block and a second thread size for conjoint rotation with a second nut positioned on said right portion of said partially bifurcated clamping block;
whereby rotation of said screw in a first direction causes said accommodating hole to open a differential amount by virtue of said two different thread sizes, thereby allowing the clamping assembly to grip said adjusting shaft positioned within said accommodating hole to within a required tolerance without causing friction forces on said adjusting shaft.

2. The gripping device as set forth in claim 1, wherein each revolution of the screw in said first direction causes the right part of said clamping block to move a distance X to the right and the left part of said clamping block to move X+Δx to the right, thereby resulting in said accommodating hole to become wider by an amount Δx, thus allowing the clamping assembly to grip said adjusting shaft to within said required tolerance without causing said friction forces on said adjusting shaft.

3. The gripping device as set forth in claim 1, wherein each revolution of the screw in a second direction, opposite said first direction, causes the right part of said clamping block to move a distance X to the left and the left part of said clamping block to move X+Δx to the left, thereby resulting in said accommodating hole to become narrower by an amount Δx.

4. A clamping assembly for achieving frictionless adjustment, the clamping assembly comprising:
a clamping block being partially bifurcated into respective left and right portions along a longitudional axis, said clamping block further including an accommodating hole centered along said longitudional axis;
a screw extending in a direction perpendicular to said longitudional axis having two thread sizes, a first thread size for conjoint rotation with a first nut positioned on said left portion of said partially bifurcated clamping block and a second thread size for conjoint rotation with a second nut positioned on said right portion of said partially bifurcated clamping block;
whereby rotation of said screw in a first direction causes said accommodating hole to be forced open by a differential amount by virtue of said two different thread sizes, thereby allowing the clamping assembly to grip said adjusting shaft positioned within said accommodating hole to within a required tolerance without causing friction forces on said adjusting shaft.

5. The clamping assembly as set forth in claim 4, wherein said accommodating hole accommodates an adjusting shaft;

6. The clamping assembly as set forth in claim 4, wherein each revolution of the screw in said first direction causes the right part of said bifurcated clamping block to move a distance X to the right and the left part of said bifurcated clamping block to move X+Δx to the right, thereby resulting in said accommodating hole becoming forced open by an amount Δx.

7. The clamping assembly as set forth in claim 4, wherein each revolution of the screw in a second direction, opposite said first direction, causes the right part of said clamping block to move a distance X to the left and the left part of said clamping block to move X+Δx to the left, thereby resulting in said accommodating hole to become narrower by an amount Δx.

8. A method for achieving accurate frictionless adjustment, the method comprising:
(a) loosening a clamping cell by rotating a screw of the clamping cell to cause the clamping cell to be forced open thereby allowing an adjusting shaft to move easily within one or more guiding bushes;
(b) allowing said adjusting shaft and vacuum suction cup, attached thereto, to draw itself to a shaft of an adjustment jig to achieve a prescribed dimension and tolerance between a servo connection point and the vacuum suction cup; and
(c) manually re-tightening the clamping cell via a screw mechanism on said clamping cell, thereby preserving said prescribed dimension and tolerance between a servo connection point and the vacuum suction cup.

9. The method as set forth in claim 8, wherein said step (b) of allowing said adjusting shaft and vacuum suction cup, attached thereto, to draw itself to a shaft of the adjustment jig to achieve a prescribed dimension and tolerance between a servo connection point and the vacuum suction cup, is performed via vacuum means.
